(19) United States
(12) Patent Application Publication
(10) Pub. No.: US 2013/0191858 A1
(43) Pub. Date: Jul. 25, 2013

(54) Broadcast Encoding, Recording and Distribution System and Method

(71) Applicants: Chaitanya Kanojia, West Newton, MA (US); Joseph Thaddeus Lipowski, Norwell, MA (US)

(72) Inventors: Chaitanya Kanojia, West Newton, MA (US); Joseph Thaddeus Lipowski, Norwell, MA (US)

(73) Assignee: AEREO, INC., Long Island City, NY (US)

(21) Appl. No.: 13/358,334

(22) Filed: Jan. 25, 2012

(51) Int. Cl. H04N 21/25; H04N 21/2665

(52) U.S. Cl. 725/25; 725/93

(57) ABSTRACT

A method and system for capturing, storing, and streaming over the air broadcasts based on user requests is disclosed. The system and method utilize an antenna system that receives all the different frequency channels simultaneously. The received signals are then amplified and a series of filters are used to filter the signal to differentiate the different frequencies. The signals are then decoded and duplicated for each user based on user requests.

### BACKGROUND OF THE INVENTION

Over the air television, which is also referred to as terrestrial television or broadcast television, is a distribution mode for television content via radio frequency (RF) electromagnetic waves or radiation through the atmosphere. Some examples of well known television networks in the United States that broadcast over the air content are ABC, CBS, FOX, NBC, and PBS. Through a series of affiliate stations, these networks are able to blanket the country with broadcasted content. The result is that each one of these television networks is able to reach over 95% of all the households in the United States.

Television networks are always looking for ways to attract new customers and increase viewership. Recently, some television networks have been putting their programming online for people to access via private and public data networks such as the Internet. Typically, the television networks will upload content to their website or some other third party website, such as HULU.COM, that streams the content to users, sometimes for a fee. Today, the content that is available is often limited; sometimes, the most recent episodes are not available or the content is outdated.

At the same time, a wide variety of devices are available that can play audio and video content. In addition to the ubiquitous television, many now watch video on their personal computers and mobile computing devices, such as smartphones and tablet computers. Video content is usually accessed through the Internet using subscriber data networks, cellular phone networks, and public and private wireless data networks. Moreover, some televisions now have network connections. And, many game consoles have the ability to access video content using third-party software such as provided by Netflix, Inc.

### SUMMARY OF THE INVENTION

Despite all of the new modalities for viewing video, over the air content broadcast by the traditional television networks is still generally only available through cable television subscriptions, satellite television systems, or by capturing the over the air broadcasts with a home-installed antenna.

Moreover, for users that install their own RF or satellite antenna in order to capture broadcast content, this captured content is generally only available for display on a traditional television. There is generally no simple way for a user to have this content available to their other video-capable devices.

U.S. patent application Ser. No. 13/299,186, now U.S. Pat. Appl. Publ. No. ______, entitled “System and Method for Providing Network Access to Antenna Feeds,” which is incorporated herein in its entirety by this reference, for example, describes a system for capturing, storing, and streaming over the air broadcasts based on user requests. That system and method utilize assigned antenna elements for receiving over the air broadcasts. Then processing pipelines are used to demodulate and transcode the content transmissions to generate content data that is saved in file store and/or streamed to users over a network.

In alternate scenarios, the antennas can be shared by multiple users, however. In such systems, an antenna system is used or a single antenna is dedicated to each of the channels that users may want to watch and this way capture the broadcast content transmissions for those channels. The content data for each of the channels are then duplicated for users based on user requests. Lastly, the content data are then streamed to the users and/or stored in a storage device.

In general, according to one aspect, the invention features a system for distributing content transmissions to users. The system comprises an application server that receives requests from the users for access to broadcasted content transmissions and a content capturing subsystem that captures the broadcasted content transmissions via an antenna system and then duplicates the content transmissions to generate corresponding content data for each of the user requests.

In one embodiment, a stream controller instructs the content capturing subsystem to duplicate the content data based on the requests of the users.

Preferably, the content data are stored in a file store and associated with user accounts of the users that requested the content data such that users have individual copies of the content data in the file store. Generally, users are only able to access the copy of the content data associated with their user account.

In general, according to one aspect, the invention features a method for distributing content transmissions to users. The method comprises receiving requests from the users for access to broadcasted content transmissions, capturing the broadcasted content transmissions via an antenna system, and duplicating the content transmissions to generate corresponding content data for each of the requests of the users.

In general, according to another aspect, the invention features a system for distributing content transmissions to users. The system comprises an application server that receives requests from the users for access to broadcasted content transmissions, a content capturing system that captures the broadcasted content transmissions via an antenna system, and a switching unit that selectively connects the captured broadcasted content transmissions to decoders based on the user requests. The content capturing system uses processing pipelines to generate content data for each of the user requests.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is block diagram illustrating a system for the capture and distribution of terrestrial television content that utilizes a shared antenna system to capture over the air broadcasts.

FIG. 2 is a block diagram illustrating how the streams of the pipeline are saved for each user in the broadcast file store.

FIG. 3 is block diagram showing an alternate embodiment of the system for the capture and distribution of terrestrial television content.

### DETAILED DESCRIPTION OF THE PREFERRED EMBODIMENTS

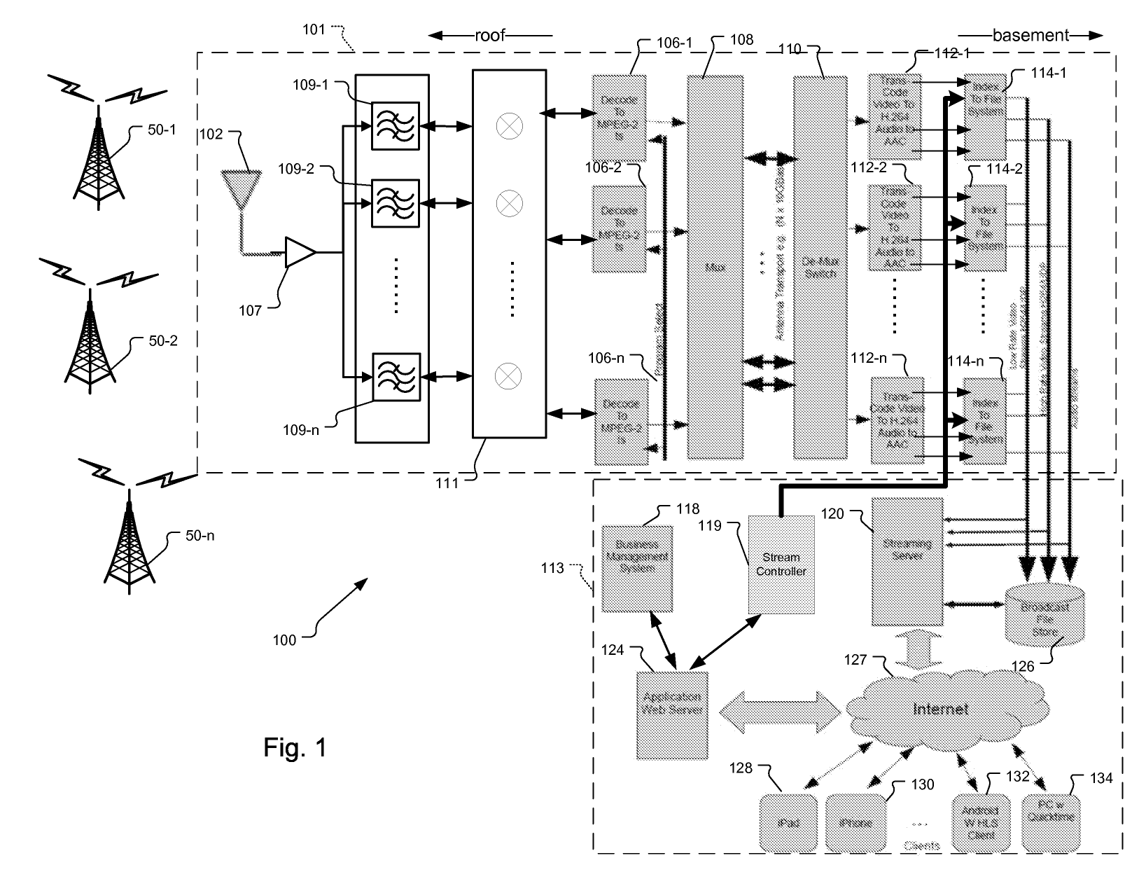

FIG. 1 is block diagram illustrating a system 100 for the capture and distribution of terrestrial television content that utilizes an antenna system 102 to capture over the air broadcasts from multiple broadcasting entities 50-1 to 50-n simultaneously and then deliver that content via a packet network such as the Internet 127 or other public or private network.

Generally, the system 100 comprises a broadcast capture subsystem 101 that captures the over the air broadcasts, decodes the over the air broadcasts as content data, and then creates duplicate copies of the content data for each of the users that request them. The duplicate copies of the content data are then streamed to users with a content data distribution subsystem 113 that includes a streaming server 120 and a file store 126, which stores the content data. The content data distribution subsystem 113 receives users' requests for live or recorded television content and then takes the content data in the user accounts and transmits the content data to the users via the Internet 127 or other public or private data network.

In a typical implementation, users access the system 100 via a network such as the Internet 127 or a combination of public and private networks including cellular networks, with client devices 128, 130, 132, 134. In one example, the client device is a personal computer 134 that accesses content data distribution subsystem 113 via a browser. The video content is displayed on the personal computer using HTML-5 or a program such as QuickTime by Apple Corporation. In other examples, the system 100 is accessed by mobile devices such as tablets, e.g., iPad mobile computing device, mobile phones, e.g., iPhone computing device, or mobile computing devices running the Android operating system by Google Inc. Here, also HTML-5 is used in some implementations to provide the video. Other examples are televisions that have network interfaces and browsing capabilities. Additionally, many modern game consoles and some televisions also have the ability to run third-party software and provide web browsing capabilities that can be deployed to access the video from the system 100 over a network connection.

An application server 124 of the content data distribution subsystem 113 manages these requests or commands from the client devices 128, 130, 132, 134. It allows the users with the client devices to select whether they want to watch or access previously recorded content, e.g., television program, set up a future recording of content, or watch a live broadcast of a television program. In some examples, the system 100 also enables users to access and/or record audio-only (e.g., radio) broadcasts. A business management system 118 is used to verify and manage the users' accounts or help users set up a new account if they do not yet have one.

If the users request to watch previously recorded content, then the application server 124 sends the users' request to the streaming server 120. The streaming server 120 retrieves each users' individual copy of the previously recorded content from the broadcast file store (or file store) 126 and streams content data to the client devices 128, 130, 132, 134 via the Internet 127.

If the users request to set up future recordings, the application server 124 communicates with a stream controller 119 to configure the broadcast capture subsystem 101 to generate a duplicate copy for the account of the requesting user of the captured over the air broadcast when the television program is broadcast.

Similarly, if the users request to watch a live broadcast, then the application server 124 communicates with the stream controller 119, which configures the broadcast capture subsystem 101 to generate a duplicate copy of the content transmission for that user's account. In this scenario, however, the recording and/or streaming of the content data begins immediately, or in an alternative example, the recording begins first to establish and adequate amount of buffered content data before the streaming of the content data to the requesting users begins.

The captured over the air broadcasts, which are referred to as content transmissions, are decoded and transcoded by the broadcast capture subsystem 101. The transcoded content transmissions are associated with users' accounts based on the user requests and then stored in the broadcast file store 126 as content data. Each requesting user has an individual copy of their requested content data associated with their user account in the broadcast file store 126. Additionally, users are only able to access the content data that are associated with their user account.

If the user requested to access a live broadcast, then the broadcast file store 126 also acts as a buffer for the streaming server 120 to allow users to pause and replay parts of the programs. Likewise, the content data are also saved in the file store 126 to enable users to access the recorded content data at later times as well.

The broadcast capture subsystem 101 captures all of the over the air broadcasts of the broadcasting entities 50-1 to 50-n within the local geographic region and decodes the captured television programming. Generally, the broadcast capture subsystem 101 captures and encodes over the air broadcasts continuously for all broadcasts coming from the entities 50-1 to 50-n. The implicit assumption is that at least one user of the system 100 will want to watch each of the television programs from the entities 50-1 to 50-n.

The over the air broadcasts from the different broadcasting entities 50-1 to 50-n are captured by the antenna system 102 of the broadcast capture subsystem 101. The antenna system 102 is typically able to capture over the air broadcasts within, for example, the VHF (very high frequency) and UHF (ultra high frequency) frequency range to receive all the over the air broadcasts from a wide range of frequencies and from the multiple broadcasting entities 50-1 to 50-n simultaneously.

The received (or captured) over the air broadcasts, which are referred to as content transmissions, are then amplified by an amplifier 107, if required. Often, the system will be located in close physical proximity to the broadcasting towers used by the entities 50-1 to 50-n so that single strength will be adequate. The captured signal is then filtered by band-pass filters 109-1 to 109-n to separate the captured signal into the carrier signals that encode the different channels of the different broadcasting entities 50-1 to 50-n. For each carrier signal/television channel, there is corresponding band-pass filter designed to reject or attenuate the other carrier signals that are outside of the desired frequency range of the intended carrier signal, in some embodiments. The different channels are then sent to a heterodyning unit 111. The heterodyning unit includes heterodyning circuits that shift the captured signals into baseband or a lower frequency signal to enable decoding of the carrier signals for each of the channels.

The broadcast capture subsystem 101 is further comprised of encoding components that create parallel processing pipelines for each of the content transmissions. The encoding components are able to demodulate and decode the separate content transmissions from the antenna system 102 into MPEG-2 format using an array of ATSC (Advanced Television Systems Committee) decoders (or demodulators) 106-1 to 106-n. Typically, each of the decoders 106-1 to 106-n is dedicated to one of the processing pipelines. In a situation where each broadcast carrier signal contains multiple content transmissions, the ATSC decoders 106-1 to 106-n are able to select the desired program contained on the carrier signal. The content transmissions are decoded to MPEG-2 content transmission data because it is currently a standard format for the coding of moving pictures and associated audio information.

The content transmission data from the ATSC decoders 106-1 to 106-n are sent to a multiplexer 108. The content transmissions are then transmitted across an antenna transport interconnect to a demultiplexer switch 110. In a preferred embodiment, the antenna transport interconnect is an nx10GbE optical data transport layer.

In the current implementation, the antenna system 102, band-pass filters 109-1 to 109-n, heterodyning unit 111, and decoders 106-1 to 106-n are located outside in an enclosure that is installed on the roof of a building or on an antenna tower. These components are often made to be relatively robust against temperature cycling that would be associated with such an installation. The nx10GbE data transport is used transmit the captured content transmission data to the remaining components of the processing and encoding pipeline that are preferably located in a secure location such as a ground-level but or the basement of the building, which usually has a better controlled ambient environment.

The content transmission data of each of the antenna processing pipelines are then transcoded into a format that is more efficient for storage and streaming. In the current implementation, the transcode to the MPEG-4 (which uses video standard known as H.264) format is effected by an array of transcoders 112-1, 112-2 . . . 112-n. Typically, multiple transcoding threads run on a single signal processor core or FPGA or ASIC type device.

The content transmission data are transcoded to MPEG-4 format at multiple resolutions to reduce the bitrates and the sizes of the data footprints. In one embodiment, the transcode is performed to three or more separate resolutions to accommodate a wide variety of display devices and network transmission restrictions. As a consequence, the conversion of the content transmission data to MPEG-4 encoding will reduce the picture quality and/or resolution of the content, but this reduction is generally not enough to be noticeable for the average user on a typical reduced resolution video display device. The reduced size of the content transmissions will make the content transmissions easier to store, transfer, and stream to the user devices. Similarly, audio is transcoded to AAC in the current embodiment, which is known to be highly efficient.

In one embodiment, the transcoded content transmission data are sent to a packetizers and indexers 114-1 to 114-n of the pipelines, which packetize the data. The indexers receive commands from the stream controller 119 that command the indexers to create duplicate copies of the content transmission data based on requests from users. Thus, for each user request, a corresponding duplicate copy of the content transmission is generated by an indexer for the requesting users' accounts.

In the current embodiment, the packet protocol is UDP (user datagram protocol), which is a stateless, streaming protocol. UDP is a transmission model that provides less reliable service because datagrams may arrive out of order, duplicated, and go missing. Generally, this protocol is preferred for time-sensitive transmission, such as streaming files, where missing or duplicated packets can be dropped and there is no need to wait for delayed packets

Also, in this process, time index information is added to the content transmissions. The content data are then transferred to the broadcast file store 126 for storage to the file system, which is used to store and/or buffer the content transmissions as content data for the various television programs being captured for the users.

In an alternative embodiment, the content data are streamed as HTTP Live Streaming or HTTP Dynamic Streaming. These are streaming protocols that are dependent upon the client device. HTTP Live Streaming is a HTTP-based media streaming communications protocol implemented by Apple Inc. as part of its QuickTime X and iPhone software systems. The stream is divided into a sequence of HTTP-based file downloads.

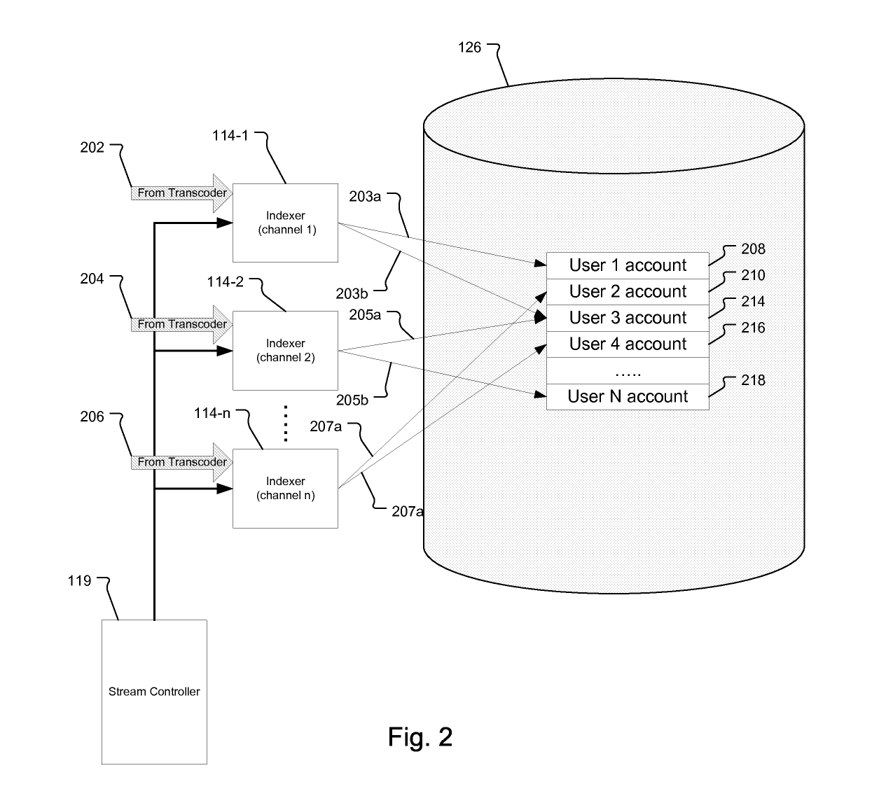

FIG. 2 is a block diagram illustrating how the stream controller 119 instructs the indexers 114-1 to 114-n to generate duplicate copies of the content transmissions and save the content transmissions as content data in the broadcast file 126. Each duplicate of the content transmission is associated with one of the user accounts. Thus, each user receives a unique copy associated with their user account of the content data for their requested television programs, for example. Moreover, users are thereafter only able to access the content data associated with their user account.

In the illustrated example, each indexer 114-1 to 114-n receives a transcoded content transmission 202, 204, 206 from one of the transcoders 112-1 to 112-n in the same processing pipeline, the corresponding content data includes the content transmission and multiple, such as three, resolutions. In a typical implementation, each processing pipeline is dedicated to one of the channels of the broadcasting entities. In response to instructions from the stream controller 119, the indexers 114-1 to 114-n generate a copy of the content data 203a, 203b, 205a, 205b, and 207a, 207b for each user that has requested to watch or record the corresponding television program, for example. To illustrate a specific example: suppose indexer 114-2 handles channel 2 which is broadcasting television program X. If User 3 and User n desire to watch or record television program X, then indexer 114-2 sends a copy of the content data for television program X to the user accounts for User 3 and User N.

In the illustrated example, the first indexer 114-1 generates copies of content data 203a, 203b for User 1's account 208 and User 3's account 214. Another indexer 114-2 generates copies of content data 205a, 205b for User 3's account 208 and for User N's account 218. Lastly, another indexer 114-n, generates copies of content data 207a, 207b for User 2's account 210 and for User 4's account 216.

Even if no users are currently requesting a channel, the broadcast capture subsystem 101 and content data distribution subsystem 113 still capture and encode the content transmission in one embodiment. The broadcast file store 126, however, does not save the content transmission permanently or associate it with any user accounts. Instead, the broadcast file 126 operates as a temporary storage. Typically, this is performed with a ring (or circular buffer) that can be accessed by users that newly switch to the associated channel. Once the program is complete and if no users have requested it, then the contents of this temporary storage are flushed.

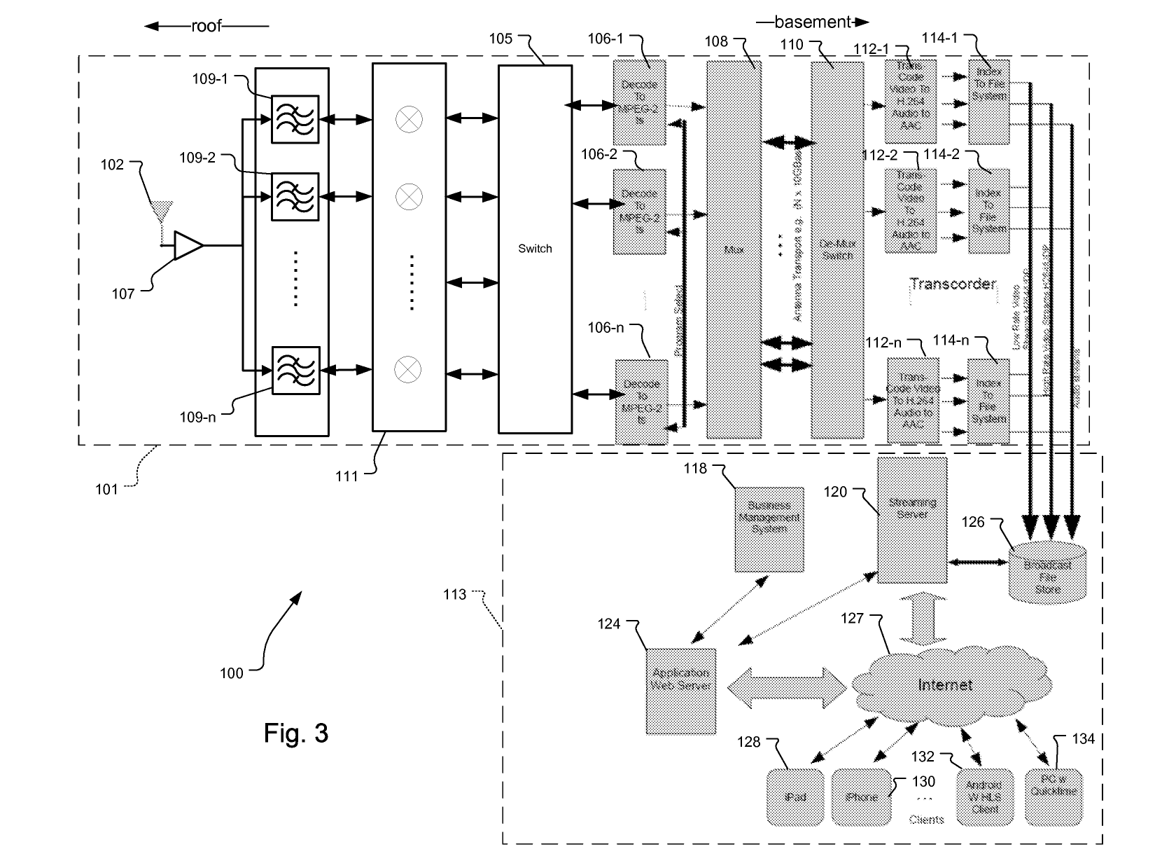

FIG. 3 is block diagram showing another embodiment of the system 100 for the capture and distribution of terrestrial television content that utilizes an antenna system 102 to capture over the air broadcasts from multiple broadcasting entities 50-1 to 50-n simultaneously and then deliver that content via a packet network such as the Internet 127 or other public or private network.

The broadcast capture portion of the system 100 includes an antenna system 102, amplifiers 107 (if required), filters 109 (if required), and heterodyning units 111 as before.

In this embodiment, however, the content transmissions are then sent to a switching unit 105 that selectively connects each channel in the heterodyning unit 111 to individually assigned demodulators 106-1 to 106-n. Here, each user is assigned a unique processing pipeline. If a user wishes to watch a over the air broadcast from a different broadcasting entity 50-1 to 50-n (i.e., switch channels), then the switching unit 105 connects the user's assigned demodulator to the corresponding output of the heterodyning unit 111. In summary, in this embodiment, the per-user duplication is performed by the switch 105 rather than by the indexers 114.

The remainder of the processing pipeline and the content data distribution subsystem 113 generally operates as before, except that the indexers 114-1 to 114-n do not receive commands from the stream controller or create duplicate copies. Each indexer stores the content data of television program requested by a single user to the file store 126.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for distributing content transmissions to users, comprising:
an application server that receives requests from the users for access to broadcasted content transmissions; and
a content capturing subsystem that captures the broadcasted content transmissions via an antenna system and then duplicates the content transmissions to generate corresponding content data for each of the user requests.

2. The system according to claim 1, further comprising a stream controller instructs the content capturing subsystem to duplicate the content data based on the requests of the users.

3. The system according to claim 1, wherein the content data are stored in a file store and associated with user accounts of the users that requested the content data.

4. The system according to claim 3, wherein users have individual copies of the content data in the file store.

5. The system according to claim 4, wherein users are only able to access the copy of the content data associated with their user account.

6. A method for distributing content transmissions to users, the method comprising:
receiving requests from the users for access to broadcasted content transmissions;
capturing the broadcasted content transmissions via an antenna system; and
duplicating the content transmissions to generate corresponding content data for each of the requests of the users.

7. The method according to claim 6, duplicating the content data in response to the requests of the users.

8. The method according to claim 6, further comprising storing the content data in a file store for each of the users that requested the content data.

9. The method according to claim 8, further comprising restricting each of the users to access only their copy of the content data from the file store.

10. A system for distributing content transmissions to users, comprising:
an application server that receives requests from the users for access to broadcasted content transmissions;
a content capturing system that captures the broadcasted content transmissions via an antenna system;
a switching unit that selectively connects the captured broadcasted content transmissions to decoders based on the user requests; and
wherein the content capturing system uses processing pipelines to generate content data for each of the user requests.
